(19) United States
(12) Patent Application Publication
(10) Pub. No.: US 2011/0134079 A1
(43) Pub. Date: Jun. 9, 2011

(54) TOUCH SCREEN DEVICE

(75) Inventor: Laurence Stark, Edinburgh (GB)

(73) Assignee: STMicroelectronics (Research & Development) Limited, Marlow (GB)

(21) Appl. No.: 12/956,832

(22) Filed: Nov. 30, 2010

(30) Foreign Application Priority Data
Dec. 3, 2009 (GB) 0921216.8

(51) Int. Cl. G06F 3/042; H01J 40/14

(52) U.S. Cl. 345/175; 250/221

(57) ABSTRACT

A radiation source emits radiation, with respect to a touch sensitive surface, which is detected by a corresponding sensor. By sensing radiation levels in a sensing plane substantially parallel with said surface, a determination is made as to an instance of at least one touch of the surface by a touching object. Furthermore, the sensed radiation levels are processed to determine a relative pressure applied to the surface by the at least one touch based upon a parameter related to an approaching speed of the touching object.

### PRIORITY CLAIM

This application claims priority from United Kingdom Application for Patent No. 0921216.8 filed Dec. 3, 2009, the disclosure of which is hereby incorporated by reference.

### TECHNICAL FIELD

This application relates to touch sensitive screens and in particular touch sensitive screens capable of resolving simultaneous touches at multiple points which are also pressure sensitive.

### BACKGROUND

Touch screen systems implementing both multi-touch and pressure sensitive functionality are rare due to the difficulty in solving technical problems presented while maintaining cost-effectiveness. Reliably detecting the touch locations of multiple points, and their corresponding pressure levels, while ensuring that the quality of the display is not compromised by any screen overlays, presents a significant hurdle for most touch screen technologies.

Known touch screen technologies, and their known drawbacks, include:
Capacitive: Does not scale up in size as well as other technologies, requires human touch for detection due to capacitive properties (does not work with gloved hand for example). Capacitive screen coating transparency about 90%.
SAW (surface acoustic wave): requires soft object to absorb waves and detect touch points.
Resistive: Resistive screen overlay can be damaged by sharp objects & has only about 75% transparency.
Force-sensing: Does not allow multi-touch sensing with a solid screen, multiple points of contact are resolved to a single co-ordinate.

There is a need in the art to address the issue of pressure sensitivity in multi-touch touch-screens.

### SUMMARY

In a first aspect there is provided a display comprising a touch sensitive surface, at least one radiation source and at least one corresponding sensor such that said display can determine by sensing radiation levels in a sensing plane substantially parallel with said surface, the position on said surface of one or more touches by an object, wherein said touch display is operable to determine the relative pressure applied to the touch sensitive surface by a touch based upon a parameter related to the approaching speed of the touching object.

The approaching speed of the touching object may be determined by determination of the rate of change of said parameter from two or more frames imaged between the time said object enters the sensing plane and the time it touches the surface. Said parameter may comprise light intensity, and specifically the light intensity on the portion of the sensor affected by the touching object. Said sensor may comprise an array of individually addressed pixels and said device may be operable to determine the point of lowest intensity and to monitor movement of this point of lowest intensity during said two or more successive frames. Alternatively or in addition said device may be operable to determine said rate of change of intensity from the rate of change of the slope at one or more points on a light intensity profile across said array and/or the rate of change of the width between pixels registering the same intensity levels at one or more points on said light intensity profile. For example, one measurement point may be the midpoint between a touch threshold corresponding with the sensing plane and a minimum touch point corresponding with the display surface.

Said device may comprise said at least one radiation source and said at least one corresponding sensor arranged to emit in and detect radiation from said sensing plane. There may be first and second sets of radiation sources, each with corresponding sensors, both sets of radiation sourced emitting radiation in the sensing plan, said first set emitting radiation in a direction perpendicular to the second set. Said radiation sources and sensors may work together in either absorption, retro-reflective or imaging modes. “Sets” of radiation sources and sensors may include a single radiation source and/or sensor.

Said device may be operable to offset the integration phases of said first set of radiation sources and corresponding sensors in relation to said second set. Said offsetting should be such that only one of said first and second sets of radiation sources is turned on, and integration only performed on data from the corresponding set of sensors, at any one time. In a preferred embodiment, both of said offset integration phases for said first and second sets of radiation sources and corresponding sensors, should be performed in a total timeframe similar to that when performing said phases simultaneously. As a consequence said single integration phase speed may be substantially doubled in comparison to that practicable should integration be simultaneously performed on data from both sets of sensors

Said touch sensitive surface may be separately sensitive to two or more simultaneous touches, and may be able to determine each position of said two or more simultaneous touches.

In a further aspect there is provided a display comprising a touch sensitive surface and first and second sets of radiation sources each with corresponding sensors, said radiation sources being arranged to emit radiation in a single sensing plane substantially parallel with said surface, said first set being operable to emit radiation perpendicular to the second set, such that said device can determine by sensing radiation levels in a sensing plane parallel with said surface, the position on said surface, of one or more touches by an object, wherein said device is operable to offset the integration phases of said first set of radiation sources and corresponding sensors, in relation to said second set.

Said offsetting should be such that only one of said first and second sets of radiation sources is turned on, and integration only performed on data from the corresponding set of sensors, at any one time. Both of said offset integration phases for said first and second sets of radiation sources and corresponding sensors, may be performed in a total timeframe similar to that when performing said phases simultaneously. As a consequence said single integration phase speed may be substantially doubled in comparison to that practicable should integration be simultaneously performed on data from both sets of sensors
Said radiation sources and sensors may work together in either absorption, retro-reflective or imaging modes.

Said touch sensitive surface may be separately sensitive to two or more simultaneous touches, and may be able to determine each position of said two or more simultaneous touches.

### BRIEF DESCRIPTION OF THE DRAWINGS

Embodiments of the invention will now be described, by way of example only, by reference to the accompanying drawings, in which:

FIG. 1 shows a sensor arrangement in cross-section according to an absorption mode assembly;

FIG. 2 shows a light intensity profile for a single touch point detected by a sensor;

FIG. 3 shows the evolution of the light intensity profile for a single touch point in absorption mode;

FIG. 4 illustrates phase offset between the X-sensor and Y-sensor;

FIG. 5 shows the light intensity gradient on screen during X illumination using the phase offset method illustrated in FIG. 4; and

FIG. 6 shows, for comparison, the light intensity gradient on screen using the conventional synchronized phase method.

### DETAILED DESCRIPTION OF THE DRAWINGS

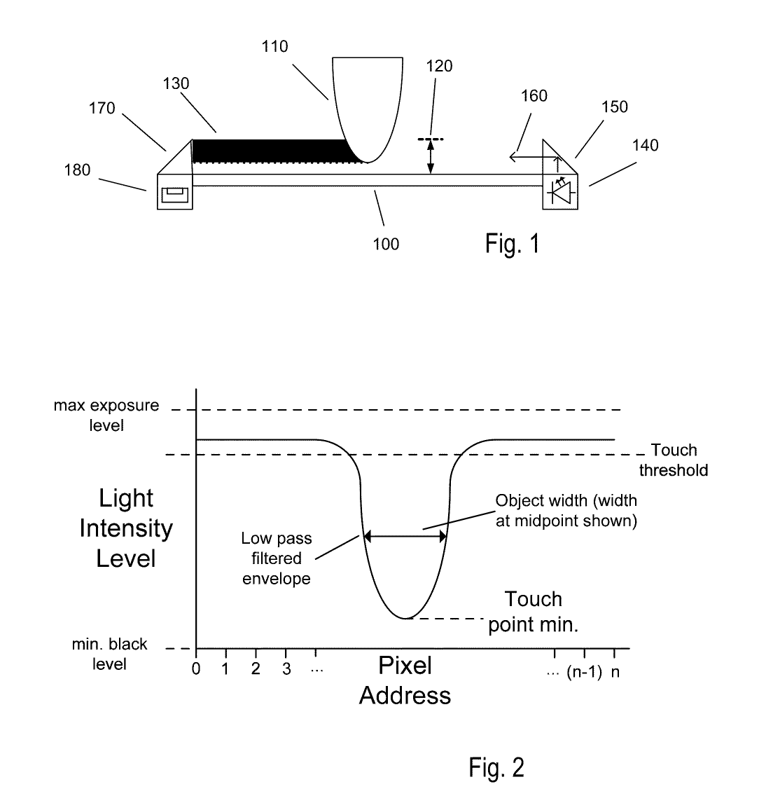

FIG. 1 shows a touch sensitive screen arrangement. It shows a screen surface 100, a contacting object 110 (such as a finger), the z-plane detection limit 120, the finger's shadow 130, the illumination source (an LED in this example) 140, illumination optics 150, light beam 160, the imaging optics 170 and sensor pixel array 180. Data processing apparatus is coupled to the sensor pixel array.

The system actually consists of two sensor arrays 180X, 180Y (FIG. 5) mounted in a rectangular frame, an x-axis sensor and a y-axis sensor. The arrangement of the optics 150, 170 and polarity of the light intensity profile will depend on the mode in which the system is used. The system described is setup in an absorption mode, but can also be used in a retro-reflective or imaging mode:
Absorption: each sensor will have a corresponding infrared LED mounted on the opposite side of the screen. Light is absorbed by the contacting object.
Retro-reflective: light is reflected across the screen and back to the sensor.
Imaging: the contacting object will be illuminated when it enters the z-plane detection zone.

The illumination optics 150 are used to focus and evenly distribute the light output 160 from the LEDs 140, across the screen along the respective axis, and onto the imaging optics 170 which in turn focuses the light onto the pixel array 180.

The z-dimensions of the imaging and illumination optics 170, 150 determine the height of the z-plane detection zone 120. The imaging and illumination optics should be matched in z-height to maximize the percentage of light from the illumination LED which is received by the pixel.

The inventor has determined that such a device can be made sensitive to the vertical (z-dimension) speed at which the contacting object 110 (e.g. a finger) approaches the screen 100, which in turn can be used to emulate sensing of the pressure applied to the screen 100 by said object 110.

When the contacting object 110 breaks the z-plane detection limit 120 of the optics 150, 170, it begins to block the light 160 directed at the pixel array 180, reducing the intensity levels recorded at the end of the frame for the affected pixels. When the contacting object 110 makes contact with the surface 100 of the screen, the light levels of the pixels 180 in the affected area will be at their lowest levels.

FIG. 2 shows a graph illustrating how the light intensity level varies with the pixel address (that is position of the pixel) when the screen is touched. The trace shown is for an object actually contacting the screen. A touch point is initially detected by the processing unit when the detected light intensity profile for a frame drops below a defined ‘touch threshold’ level. Touch point detection could also be implemented by detecting a touch point when the light intensity profile gradient at a point exceeds a defined rate.

The speed sensing function may be performed by the processing unit through analysis of the movement of the detected minimum of a touch point for several successive frames and using this data to derive the speed of the contacting object. A number of frames, dependent upon both the frame rate of the system and the average velocity of the contacting object towards the screen while within the z-plane detection zone, between the contacting object first entering the z-plane detection zone and reaching the surface of the screen can be captured by the x and y sensors and stored in a memory bank. The speed of the contacting object moving through the z-plane detection zone can be shown to be directly proportional to the rate of change of light intensity of the pixels whose light intensity levels are affected by the contacting object blocking the projected light incident on them. Frames imaged between the time the object touches the surface and the time it leaves the sensing plane may also be used in a similar manner to those imaged before contact of the touching object to determine release ‘pressure’ for the detected touch co-ordinates.

The light intensity profiles of the stored frames allow processing unit calculation of the rate of change of minimum light intensity for the detected touch point to be made. The speed of the detected touch is output as a proportionally scaled value based on the rate of change of light intensity. The rate of change of width at one or more points, such as the halfway points between the maximum and minimum levels or the points of maximum positive and negative slopes, can also be used to derive the speed either separately from or in conjunction with the minimum point.

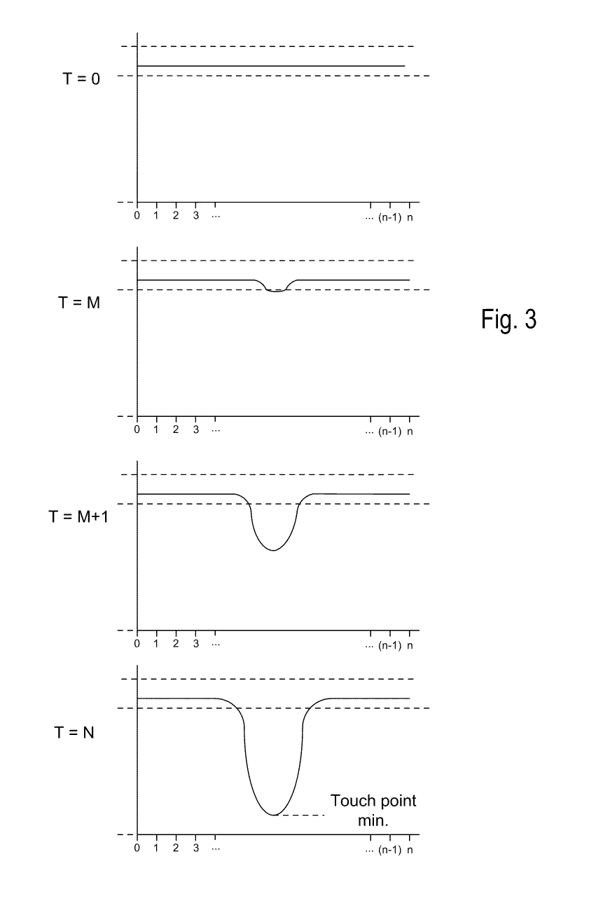

FIG. 3 shows the evolution in time of a touch point through time for a finger as the contacting object.
T=0: No contacting object is within the z-plane detection zone, no touch is detected.
T=M: A finger has entered the z-plane detection zone, causing the light levels to reach the touch threshold.
T=M+1: The contacting object continues to travel towards the screen, the width of the profile has increased as the wider part of the finger enters the z-plane detection zone. The minimum light levels have decreased as the finger is closer to the screen and allows less light through to the pixels.
T=N: The finger has come into contact with the screen and the amount of light received by the pixels is at its minimum point for the frames captured during the touch.

The accuracy of the speed sensing depends upon the number of frames captured while the contacting object is within the z-plane detection zone as a finer the temporal resolution will allow a greater number of samples of pixel data to be captured and hence improve the accuracy of the touch speed calculation. The temporal resolution of the system can be effectively doubled by doubling the clock frequency and offsetting the phases of the frames of the sensors so that when the X-sensor is in the reset & image readout phase, the Y-sensor will be in the integration phase.

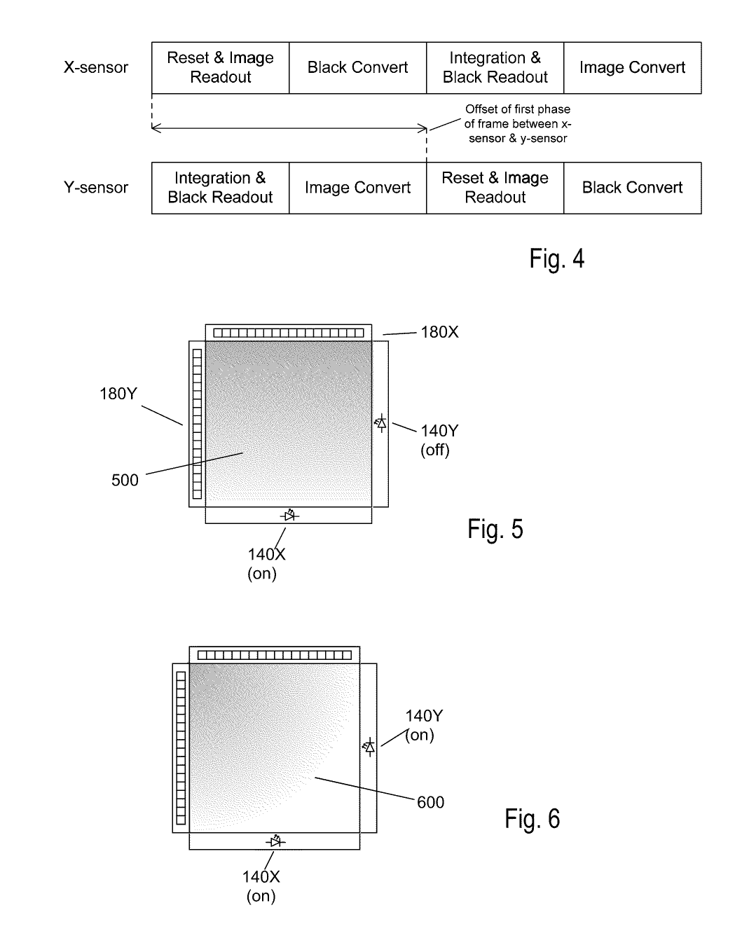

FIG. 4 illustrates the phase offset for such a method. This method has reduced hardware speed and bandwidth requirements when compared with merely doubling the master clock frequency of the system and synchronizing the integration periods of both sensors. The Black Convert phase and the Image Convert phase should be equal in length, the Reset & Image Readout and the Integration & Black Readout phases should also be of equal length so as to create a length-symmetrical frame which is required to maintain synchronism of the phase change.

When both sensors have a light intensity profile for one or more touch points that is uncorrupted by close proximity of another point or vertical or horizontal alignment of the touch points; the data for a detected touch point from each sensor can be scaled and interpolated to form a single light intensity profile for a touch point with twice the temporal resolution of the data in the frames when compared with a system with the sensors' phases running synchronously.

FIGS. 5 and 6 illustrate another advantage of using such a method. During the integration phase of either one of the sensors, the illumination LED paired with it will be illuminated for a time necessary to ensure that the dynamic range of the light levels received by the pixel array is as high as it can be without causing saturation of the pixels. If a sensor is not in its integration phase, the LED paired with it will not be illuminated. The illumination of the LEDs is mutually exclusive and therefore the light intensity gradient across the screen during the capture of a frame will be linear in a direction perpendicular to the axis upon which the integrating sensor is mounted. This linear intensity gradient 500 (shown in FIG. 5) is easier to compensate for in image processing calculations when compared with the skewed intensity gradient 600 (shown in FIG. 6) which would be present if both LEDs were lit simultaneously.

The above embodiments are for illustration only and other embodiments and variations are possible and envisaged without departing from the spirit and scope of the invention. For example the actual type of touch sensitive screen is not relevant so long as it is of a type that uses the principle of sensing radiation levels in a plane parallel with a screen surface.

What is claimed is:

1. Apparatus, comprising:
a surface,
at least one radiation source, and
at least one corresponding sensor,
said apparatus operable to determine, by sensing levels of radiation emitted from said radiation source and following an optical path to said sensor that is substantially parallel with said surface within a sensing plane, at least one touch of the surface by a touching object,
wherein said apparatus is operable to determine a relative pressure applied to the surface by the at least one touch based upon a parameter related to an approaching speed of the touching object.

2. Apparatus as claimed in claim 1, wherein said parameter comprises light intensity.

3. Apparatus as claimed in claim 2, wherein said sensor comprises an array of individually addressed pixels, said apparatus operable such that the approaching speed of the touching object is determined by determination of the rate of change of said parameter from two or more frames imaged between a time said object enters the sensing plane and a time the object touches the surface.

4. Apparatus as claimed in claim 3, wherein said parameter specifically comprises the light intensity on the portion of the sensor affected by the touching object.

5. Apparatus as claimed in claim 3, said apparatus being operable to determine said rate of change of light intensity from the rate of change of the slope at one or more points on a light intensity profile across said array.

6. Apparatus as claimed in claim 3, said apparatus being operable to determine said rate of change of light intensity from the rate of change of the width between pixels registering the same intensity levels at one or more points on a light intensity profile across said array.

7. Apparatus as claimed in claim 3, said apparatus being operable to determine the approaching speed of the touching object by determining the point of lowest intensity and to monitor movement of this point of lowest intensity during said two or more successive frames.

8. Apparatus as claimed in claim 1, comprising said at least one radiation source and said at least one corresponding sensor arranged respectively to emit radiation into, and detect radiation from, said sensing plane.

9. Apparatus as claimed in claim 8, comprising first and second sets of radiation sources, each with corresponding sensors, both sets of radiation sourced emitting radiation in the sensing plane, said first set emitting radiation in a direction perpendicular to the second set.

10. Apparatus as claimed in claim 9, wherein said radiation sources and sensors work together in either absorption, retro-reflective or imaging modes.

11. Apparatus as claimed in claim 9, said apparatus being operable to offset the integration phases of said first set of radiation sources and corresponding sensors in relation to said second set.

12. Apparatus as claimed in claim 11, said apparatus being operable such that said offsetting is such that only one of said first and second sets of radiation sources is turned on, and integration only performed on data from the corresponding set of sensors, at any one time.

13. Apparatus as claimed in claim 11, said apparatus being operable such that both of said offset integration phases for said first and second sets of radiation sources and corresponding sensors, is performed in a total timeframe similar to that when performing said phases simultaneously.

14. Apparatus as claimed in claim 13, wherein a single integration phase speed is substantially doubled in comparison to that practicable should integration be simultaneously performed on data from both sets of sensors.

15. Apparatus as claimed in claim 1, wherein said touch sensitive surface is separately sensitive to two or more simultaneous touches, and is able to determine each position of said two or more simultaneous touches.

16. Apparatus as claimed in claim 1, operable such that measurements made to determine the approaching speed of the touching object through the sensing plane are made at a single height above said surface.

17. Apparatus as claimed in claim 1, further comprising a display, said surface being a screen of the display.

18. Apparatus, comprising:
a surface, and
first and second sets of radiation sources each with corresponding sensors, said radiation sources being arranged to emit radiation in a single sensing plane substantially parallel with said surface,
said first set being operable to emit radiation perpendicular to the second set,
said apparatus operable to determine by sensing radiation levels in the sensing plane parallel with said surface, the position on said surface, of at least one touch by an object,
wherein said apparatus is operable to offset the integration phases of said first set of radiation sources and corresponding sensors, in relation to said second set.

19. Apparatus as claimed in claim 18, said apparatus operable such that said offsetting is such that only one of said first and second sets of radiation sources is turned on, and integration only performed on data from the corresponding set of sensors, at any one time.

20. Apparatus as claimed in claim 18, said apparatus operable such that both of said offset integration phases for said first and second sets of radiation sources and corresponding sensors, is performed in a total timeframe similar to that when performing said phases simultaneously.

21. Apparatus as claimed in claim 20, wherein a single integration phase speed is substantially doubled in comparison to that practicable should integration be simultaneously performed on data from both sets of sensors.

22. Apparatus as claimed in claim 18, wherein said touch sensitive surface is separately sensitive to two or more simultaneous touches, and is able to determine each position of said two or more simultaneous touches.

23. Apparatus as claimed in claim 18, wherein said radiation sources and sensors work together in either absorption, retro-reflective or imaging modes.

24. Apparatus as claimed in claim 18, wherein said touch sensitive surface is separately sensitive to two or more simultaneous touches, and is able to determine each position of said two or more simultaneous touches.

25. Apparatus as claimed in claim 18, operable such that measurements made to determine the approaching speed of the touching object through the sensing plane are made at a single height above said surface.

26. Apparatus as claimed in claim 18, further comprising a display, said surface being a screen of the display.

27. Apparatus as claimed in claim 18, operable such that radiation from said radiation sources follows an optical path to their corresponding sensor that is substantially parallel with said surface within said sensing plane.

28. A method of determining the relative pressure applied to a surface, comprising:
emitting radiation along an optical path that is substantially parallel with said surface thereby defining a sensing plane,
determining a presence of one or more touches of a touching object by sensing radiation levels in said sensing plane,
determining a relative pressure applied to the surface by a touch based upon a parameter related to an approaching speed of the touching object.

29. A method as claimed in claim 28, wherein said parameter comprises light intensity.

30. A method as claimed in claim 29, wherein the approaching speed of the touching object is determined by determination of the rate of change of said parameter from two or more frames imaged between the time said object enters the sensing plane and the time it touches the surface.

31. A method as claimed in claim 30, wherein said rate of change of light intensity is determined from the rate of change of the slope at one or more points on a light intensity profile.

32. A method as claimed in claim 30, wherein said rate of change of light intensity is determined from the rate of change of the width between pixels registering the same intensity levels at one or more points on a light intensity profile across said array.

33. A method as claimed in claim 30, wherein the approaching speed of the touching object is determined by determining the point of lowest intensity and movement of this point of lowest intensity is monitored during said two or more successive frames.

34. A method as claimed in claim 28, further comprising operating in one of absorption, retro-reflective or imaging modes.

35. A method as claimed in claim 28, wherein integration of a first set of imaging data from one direction in the sensing plane and a second set of imaging data from a second, perpendicular, direction in the imaging plane is offset such that integration is performed on only one set of data at any one time.

36. A method as claimed in claim 35, wherein integration of both sets of data is performed in a total timeframe similar to that when performing said phases simultaneously.

37. A method as claimed in claim 36, wherein a single integration phase speed is substantially doubled in comparison to that practicable should integration be simultaneously performed on data from both sets of sensors.

38. A method as claimed in claim 28, wherein said touch sensitive surface is separately sensitive to two or more simultaneous touches, and is able to determine each position of said two or more simultaneous touches.

39. A method as claimed in claim 28, wherein measurements made to determine the approaching speed of the touching object through the sensing plane are made at a single height above said surface.
